(19) United States
(12) Patent Application Publication
(10) Pub. No.: US 2023/0024535 A1
(43) Pub. Date: Jan. 26, 2023

(54) COATED PIPE RESISTANT TO CASING WEAR

(71) Applicant: VALLOUREC OIL AND GAS FRANCE, Aulnoye-Aymeries (FR)

(72) Inventors: Xavier MENCAGLIA, Meudon (FR); Bertrand MAILLON, Meudon (FR)

(73) Assignee: VALLOUREC OIL AND GAS FRANCE, Aulnoye-Aymeries (FR)

(21) Appl. No.: 17/788,233

(22) PCT Filed: Dec. 22, 2020
(86) PCT No.: PCT/EP2020/087678

§ 371 Date: Jun. 22, 2022

(30) Foreign Application Priority Data
Dec. 23, 2019 (FR) FR1915500

(51) Int. Cl. F16L 58/08; F16L 57/06; F16L 58/18; C23C 4/06; C23C 4/129; C23C 4/131; E21B 17/042

(52) U.S. Cl. CPC F16L 58/08; F16L 57/06; F16L 58/182; C23C 4/06; C23C 4/129; C23C 4/131; E21B 17/042

(57) ABSTRACT

A steel tubular pipe, which is threaded, sleeved, or integral, includes at least one first male threaded end, an inner surface, and a metal deposition layer on the inner surface and of thickness between 0.01 mm and 0.8 mm deposited on all or part of the inner surface of the pipe.

The invention relates to tubular threaded components and more particularly steel pipes for the drilling, the exploitation of hydrocarbon wells or for the transport of oil and gas, or for geothermal or CO₂ capture wells.

Boreholes in the oil and gas industry are generally drilled in stages. Once one stage is drilled, a string of casing pipes is installed to provide to the borehole a stability of the wall and to prevent the collapse thereof as well as leaks, during the drilling of the supplementary stages. Due to this method of drilling and casing in stages, the following stages are each time deeper below the surface and have a reduction of the diameter of the borehole. For example, a four-stage well comprises four substantially concentric casing strings and therefore four distinct diameters. The last string is generally a string known as tubing string that is used to extract material from the well.

Here, “component” means any element or accessory used for drilling or exploiting a well and comprising at least one connection or connector or even threaded end, and intended to be assembled by a threading with another component in order to constitute with said other component a tubular threaded joint. The component may be for example a tubular element of relatively long length (in particular of approximately around ten metres in length), for example a pipe, or else a tubular sleeve of a few tens of centimetres in length, or again an accessory of said tubular elements (hanger, cross-over, safety valve, tool joint, sub, and similar).

The tubular components are provided with threaded ends. Said threaded ends are complementary enabling the mutual connection of two male tubular elements (Pin) and female tubular elements (Box), forming a joint. Therefore, there is one male threaded element and one female threaded element. The threaded ends known as premium or semi-premium generally include at least one abutment surface. A first abutment may be formed by two free surfaces on the threaded ends configured so as to be in contact with one another at the end of the mutual screwing of the threaded ends or during compressive stresses. The abutments are generally negative angles in relation to the main axis of the connections.

These components are subjected to axial compressive or tensile stresses, fluid internal and external pressures, bending or even twisting, possibly combined and of intensity that may fluctuate. The sealing must be ensured despite the stresses and despite the harsh conditions of use on site. The threaded joints must be able to be screwed and unscrewed a plurality of times without degradation of the performances thereof, in particular by seizing. After unscrewing, the tubular components may be reused in other operating conditions.

The drilling is carried out with a drill string comprising a string of drill pipes. During the drilling of an oil well beyond the first stage, the string of drill pipes extends into a tubed portion of the borehole and into a non-tubed portion of the borehole. During the drilling below the tubed portions of the borehole, the casing may wear due to contact with the drill string. The drilling not only involves the drilling in new portions of the formation, but also back and forth motion operations where the drill bit is moved upwardly and downwardly of the newly drilled portions of the borehole (sometimes known as “stages”) in order to smooth the surface of the borehole and provide a borehole of uniform diameter. As the drill string performs a back and forth motion, the drill string proximal in relation to the hole upward of the tubing of the drill bit causes wear of the casing pipes. Also, the rotary motions of the string of drill pipes may equally cause wear of the casing pipes, a phenomenon even more pronounced in a bent well.

The wear of the casing pipes is translated by a reduction in the thickness of the pipes, which, in turn, weakens said casing pipes. Some oil wells, due to the geometry thereof, due to drilling techniques, emphasise the wear phenomena of casing pipes. It was noted that said wear is particularly detrimental at the connection between pipes. It is not possible to increase the thickness of the pipes, which leads to increasing the weight of the pipes which is not desired. Therefore, there is a need for a solution that increases the resistance of the pipes against internal wear.

It is known from FR2742840 a tubular pipe whereof the end is covered with a protective layer at the male end, but said layer is of plastic nature and is disposed so as to protect the steel pipe against the attack of corrosive products, but does not make it possible to improve the resistance of pipes against internal wear due to the abrasion of a string of pipes in motion inside the pipe.

The invention improves the situation.

The invention is a steel tubular pipe comprising at least one first male threaded end, an inner surface and a metal deposition layer on the inner surface and of thickness between 0.01 mm and 0.8 mm.

The metal deposition layer may have a hardness between 35 HRC and 65 HRC.

The metal deposition layer may have a thickness between 0.05 mm and 0.75 mm.

The metal deposition layer may have a thickness between 0.05 and 0.2 mm.

The metal deposit on the inner surface of the pipe may be in line with the male threaded end.

According to one first embodiment, the steel tubular pipe may be of the threaded and sleeved type and that the metal coating extends over the inner surface of the pipe and over a first metal coating portion in line with the first male threaded end, a second metal coating portion in line with a second male end, and a third metal coating portion in line with the intermediate section of the sleeve.

According to one aspect, the first, second, third metal deposition portions may extend over a distance between 0.1 and 1 metre, which makes it possible to protect the pipes against excessive wear precisely at the portions the most sensitive to wear.

According to one variation wherein the pipe may be of the threaded and sleeved type, the metal coating may extend over all of the inner surface of the pipe.

In a second embodiment, the pipe may be of the integral type and the metal coating extends over the inner surface of the pipe and over a first metal coating portion in line with the first male threaded end, a second metal coating portion extends from a female end towards the first male end, each portion extending over a distance between 0.1 and 1 metre.

According to one variation, the pipe may be of the integral type and the metal coating extends over the entire inner surface of the pipe.

The coating may be applied by a metal spraying method, by high velocity oxy fuel, or by twin wire arc spray, so as to minimise the micro-structural changes in the base substrate.

According to one aspect, the pipe may be an oil well pipe or an oil well drill pipe, or an oil well string accessory.

According to another aspect, the metal coating may be chosen from chromium carbides or tungsten carbides in a cobalt or cobalt-chromium matrix or in a nickel or nickel-chromium matrix, further comprising more than 70% in weight of chromium or tungsten carbide.

Alternatively, the metal coating may comprise in weight percentage 0.5 to 4% of boron, up to 3% of carbon, up to 3% of chromium, 2 to 25% of molybdenum or tungsten, up to 20% of vanadium.

The metal coating may be arranged to have a resistance to abrasion more significant than the base steel of the tubular pipe.

The metal coating may have a porosity less than 5%, preferably less than 1%.

According to one aspect, a wall portion of the pipe comprising the metal coating has residual stresses substantially of the same level as the residual stresses of a wall portion of the pipe not comprising metal coating.

The invention is also a method for obtaining a steel tubular pipe comprising a step of metal spraying of a deposit on the inner surface of the pipe.

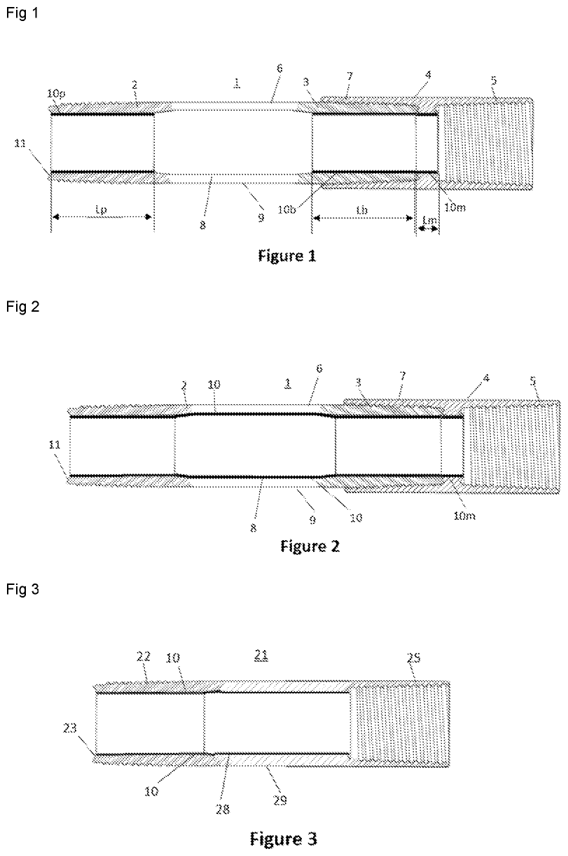

FIG. 1 schematically shows a pipe in sectional view according to a first embodiment of the invention.

FIG. 2 schematically shows a pipe in sectional view according to a variation of the first embodiment of the invention.

FIG. 3 schematically shows a pipe in sectional view according to a second embodiment of the invention.

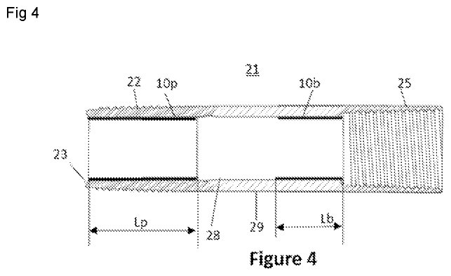

FIG. 4 schematically shows a pipe in sectional view according to a variation of the second embodiment of the invention.

The figures are not to scale, particularly in the direction of the length of the pipes, for reasons of practicality of representation.

Threaded & Sleeved Pipe

FIG. 1 shows a sectional view of a casing pipe (1) of the threaded sleeved type, provided with a first female connection (5) and with a first male connection (2). The pipe (1) comprises a first pipe (6) provided with two male connections (2, 3) and with a sleeve (4) provided with two female connections (5,7). The sleeve (4) comprises an intermediate section (14) or heel having an inner sleeved surface (15). The first pipe (6) comprises an inner surface (8) and an outer surface (9). The pipe (6) comprises on the inner surface thereof a metal coating (10) in line with the first male connection (2), extending from the male distal end (11) towards the opposite end over a coating length Lp. The metal coating (10) extends over the entire circumference of the portion of coated inner surface (8).

The coating length Lp is between 0.1 and 1 metre. Alternatively, the metal coating may extend over the entire length of the pipe.

The first pipe (1) also comprises a metal coating (10b) in line with the second male connection (3), extending over a second coating length Lb.

The sleeve (4) also comprises a metal coating (10c) at the intermediate section (14). Said coating extends over an axial length Lm.

The thickness e of the metal coating (8) is between 0.01 and 0.8 mm. Preferably, the thickness e is between 0.05 mm and 0.75 mm. Preferably, the thickness is between 0.05 and 0.2 mm. The metal coating is distinguished by the nature thereof and the thickness thereof. The thickness is chosen to prevent the inside diameter of the pipe from substantially reducing, and to maintain the transversality thereof by a string or accessories (known as “drift”).

Particularly, the metal coating is obtained by metal spraying. Metal spraying techniques make it possible not to affect the metallurgical structure of the object whereon the metal is sprayed. It is particularly important not to modify the metallurgical structure, at the connection because this is a critical element for the strength of a string of casing pipes, and also at the body of the pipe so as not to degrade the mechanical strength thereof, or again the corrosion resistance thereof. Indeed, the casing pipes are essentially pipes without welding, a weld thermally affecting the metallurgy and therefore having an influence on the mechanical resistance of the object subjected to a weld.

The metal coating is chosen from chromium carbides or tungsten carbides, particularly tungsten carbides in a Co or Co—Cr matrix, or tungsten carbides in a Ni/Ni—Cr matrix, the coating comprising, further to tungsten, 4 to 6% of carbon, 3 to 6% of chromium, 8 to 12% of cobalt.

Particularly, a tungsten carbide comprising more than 70% in weight of tungsten particles, preferably at least 85% of tungsten carbide in a cobalt-chromium matrix may be used, the coating comprising, further to tungsten, 4 to 6% of carbon, 3 to 6% of chromium, 8 to 12% of cobalt.

A tungsten carbide in a nickel-chromium matrix comprising more than 70% in weight of tungsten particles, preferably at least 85% of tungsten carbide, coating comprising, further to tungsten, 4 to 6% of carbon, 3 to 6% of chromium, 8 to 12% of cobalt.

The metal coating may comprise in weight percentage 0.5 to 4% of boron, up to 3% of carbon, up to 3% of chromium, 2 to 25% of molybdenum or tungsten, up to 20% of vanadium. In such a coating, preferably, the weight ratio of molybdenum and tungsten related to the boron is between 6 and 10.25. Such a coating has the advantage of very significantly lowering the emanations of chromium during the deposition and of being more virtuous for the environment.

Thus, the metal deposit (10) may be arranged to have a resistance to abrasion more significant than the base steel of the tubular pipe (1, 21).

Moreover, the metal deposit (10) may be arranged to have a porosity less than 5%, preferably less than 1%.

Preferably, the metal coating (8) has a hardness between 35 HRC and 65 HRC. Also preferably, the hardness is greater than 45 HRC. A high hardness allows a better resistance to wear. A hardness must be at most 65 HRC to prevent premature wear of the string of drill pipes manoeuvring inside the pipe.

The invention makes it possible to provide a resistance of the tubular component to casing wear whilst not compromising the drift of components within and whilst not compromising the performances of the connection.

The casing pipes have an inside diameter between 100 mm and 508 mm.

Preferably, the casing pipes have an inside diameter between 150 mm and 400 mm. The casing tubular component has a length between 0.01 and 15 m.

Integral Pipe

In another embodiment shown in FIG. 3, a casing pipe (21) is of the integral type, that is to say made of a single element, and is provided with a first female connection (25) and a first male connection (22). The pipe (21) comprises an inner surface (28) and an outer surface (29). The pipe (21) comprises on the inner surface thereof a metal coating (10), present in line with the first male connection (22), extending from the male distal end (23) towards the opposite female end (25) The metal coating (27) extends over the entire circumference of the portion of inner surface (28) and the metal coating (10) extends over the entire length of the pipe (21).

In a variation of this embodiment shown in FIG. 4, a casing pipe (21) is of the integral type, that is to say made of a single element, and is provided with a first female connection (25) and a first male connection (22). The pipe (21) comprises an inner surface (28) and an outer surface (29). The pipe (21) comprises over the inner surface thereof a first metal coating portion (10p) in line with the first male connection (22), extending from the male distal end (23) towards the opposite end over a coating length Lp. The metal coating (10p) extends over the entire circumference of the portion of coated inner surface (28).

The casing pipe (21) also comprises over the inner surface (28) thereof, a second metal coating portion (10b) extending from the female connection (25) to the other end over a predetermined distance Lb.

The length (Lb) of the second metal coating portion (10b) extending from the female connection (25) is between 0.1 and 1 metre, and the first metal coating portion (10p) extends from the male connection over a second length Lb between 0.1 and 1 metre. Preferably, the lengths Lb and Lp are of at least 0.2 metres.

The metal coating (10, 10p, 10b, 10m) is absent from the surface of inner threadings.

Method

The method also relates to a method for obtaining a casing pipe resistant to casing wear.

In a first step, the inner surface (8) of the pipe is prepared. Preferably, the preparation is carried out by sand blasting. Thus, the grip of the inner coating is improved. Alternatively, the preparation may be carried out by machining, in particular by turning.

In a second step, a metal coating is applied by spraying metal on the inner surface (8) of the pipe.

The metal spraying may be carried out by High Velocity Oxy Fuel (HVOF). Said method uses oxygen, a gaseous fuel as well as a filler material (powder) that will be sprayed. The spraying temperature for said technique is fairly low and also makes it possible to obtain high-density coatings and a strong bond. This method is particularly suitable for a coating applied only to a portion in line with a male connection.

Alternatively or in addition, the metal spraying may be carried out by Twin Wire Arc Spray (TWAS). The molten metal is propelled by compressed air and atomised on the substrate to form a coating. Said technique is rapid and is more indicated for applying a metal coating along the body of a casing pipe, over a large surface.

In addition, the metal spraying may be carried out by “Cold Spray”, a method for spraying powder heated and sprayed at very high velocity. This technique is complex but provides an improved performance in hardness, porosity of the coating.

This method is rapid and is compatible with an industrial implementation.

Advantageously, the material of the pipe over a wall section on which is deposited the metal coating has residual stresses substantially of the same level as the residual stresses of a wall portion of the pipe not comprising metal coating. In other words, the deposition of material does not result in the creation of additional stress in the base material or substrate.

The fine thickness of the coating makes it possible to obtain that the connection and the pipe with inner coating will be more efficient than the connection and the pipe without inner coating because the wear is significantly greater in said latter case.

Also advantageously, the coating may be applied before the machining of operational surfaces of the connection, such that a threading, a sealing surface, an abutment surface, or even after machining of the operational surfaces of the connection without the action of applying the coating before or after machining having significant influence on the mechanical properties of the connection.

This coating according to the invention is particularly effective in the case of pipes with premium connection, an assembly that is more sensitive to casing pipe wear problems.

1-17. (canceled)

18. A steel tubular pipe for drilling, exploiting hydrocarbon wells, transporting oil and gas, or geothermal or CO2 capture wells, comprising:
at least one first male threaded end,
an inner surface, and
a metal deposition layer over the inner surface and of thickness between 0.05 mm and 0.75 mm.

19. The steel tubular pipe according to claim 18, wherein the metal deposition layer has a hardness between 35 HRC and 65 HRC.

20. The steel tubular pipe according to claim 18, wherein the metal deposition layer has a thickness between 0.05 and 0.2 mm

21. The steel tubular pipe according to claim 18, wherein the metal deposition layer over the inner surface of the pipe is in line with the male threaded end.

22. The steel tubular pipe according to claim 18, wherein the steel tubular pipe is threaded and sleeved, and the metal deposition layer extends over the inner surface of the pipe and over a first metal coating portion in line with the first male threaded end, a second metal coating portion in line with a second male end, and a third metal coating portion in line with the intermediate section of the sleeve.

23. The steel tubular pipe according to claim 22, wherein the first, second, third metal coating portions extend over a distance between 0.1 and 1 meter.

24. The steel tubular pipe according to claim 18, wherein the steel tubular pipe is threaded and sleeved and the metal deposition layer extends over all of the inner surface of the steel tubular pipe.

25. The steel tubular pipe according to claim 18, wherein the steel tubular pipe is an integral type and the metal deposition layer extends over the inner surface of the steel tubular pipe and over a first metal coating portion in line with the first male threaded end, a second metal coating portion extends from a female end towards the first male end, each portion extending over a distance between 0.1 and 1 meter.

26. The steel tubular pipe according to claim 18, wherein the steel tubular pipe is an integral type and the metal deposition layer extends over the entire inner surface of the steel tubular pipe.

27. The steel tubular pipe according to claim 18, wherein the metal deposition layer is applied by a metal spraying method, by high velocity oxy fuel, or by twin wire arc spray.

28. The steel tubular pipe according to claim 18, wherein the steel tubular pipe is an oil well pipe, or an oil well drill pipe, or an oil well string accessory.

29. The steel tubular pipe according to claim 18, wherein the metal deposition layer is chosen from chromium carbides or tungsten carbides in a cobalt matrix or a cobalt-chromium matrix or in a nickel or nickel-chromium matrix, said metal deposition layer further comprising more than 70% in weight of chromium or tungsten carbide.

30. The steel tubular pipe according to claim 18, wherein the metal deposition layer comprises in weight percentage 0.5 to 4% of boron, up to 3% of carbon, up to 3% of chromium, 2 to 25% of molybdenum or tungsten, up to 20% of vanadium.

31. The steel tubular pipe according to claim 18, wherein the metal deposition layer is arranged to have a resistance to abrasion more significant than a base steel of the tubular pipe.

32. The steel tubular pipe according to claim 18, wherein the metal deposition layer has a porosity less than 5%.

33. The steel tubular pipe according to claim 18, wherein the metal deposition layer has a porosity less than 1%.

34. The steel tubular pipe according to claim 18, wherein a wall portion of the steel tubular pipe comprising the metal deposition layer has residual stresses substantially of a same level as residual stresses of a wall portion of the steel tubular pipe not comprising the metal deposition layer.

35. A method for obtaining the steel tubular pipe according to claim 18, comprising:
metal spraying of a deposit on the inner surface of the steel tubular pipe.
